(19) United States
(12) Patent Application Publication
(10) Pub. No.: US 2010/0192944 A1
(43) Pub. Date: Aug. 5, 2010

(54) SOLAR WATER HEATER AND DISTILLER

(76) Inventor: Max L. Gruber, Lake Worth, FL (US)

Correspondence Address: JOHN C. SMITH, P.A., 4125 NW 58th LANE, BOCA RATON, FL, 33496, US

(21) Appl. No.: 12/366,644

(22) Filed: Feb. 5, 2009

(51) Int. Cl. F24J 2/08; B01D 3/00; F03G 6/06

(52) U.S. Cl. 126/698; 202/234; 60/641.15

(57) ABSTRACT

A water heating/distillation chamber with multiple lenses arranged on its external walls such that direct sunlight from any direction is input into the chamber to heat the chamber contents. An input line provides water when necessary, and an output condensing structure channels water vapor out of the device for condensation into distilled water. Alternatively, a supply of hot water can be output from the chamber after heating. Alternatively, steam can be generated which can be used as an energy source for turbines. The chamber can be fabricated from glass, or any other material suitable for creating a greenhouse effect inside the chamber. The device can be applied to a wide spectrum of uses, from large scale commercial activity to small applications such as camping equipment.

### BACKGROUND

1. Technical Field

This invention relates in general to water-based systems, and more particularly it relates to a method of heating water and/or generating steam for use by solar powered water distillation systems, solar powered steam heating systems, solar powered steam turbine power systems, and solar powered cooking systems.

2. Background of the Invention

As the supply of clean water becomes scarce, there is a need for more efficient ways to increase the supply. Of course, one way to increase the supply of water is to tap into the existing sources of clean water, such as aquifers. However, this is a limited solution to the problem because such supplies can be easily exhausted, and are not available in all areas. Likewise, rising energy costs that made purification of water a more expensive proposition. It would be desirable to have a method of purifying water which requires a minimal amount of energy.

In addition to the need to purify water, there is also a need to heat water for a variety of domestic and commercial uses. For example, steam heat can be used to heat residential and commercial buildings, steam can be used to generate power via steam turbines, and water needs to be heated for cooking. Heating water typically takes substantial amounts of energy. As a result, providing hot water can be a substantial portion of the total energy cost for residential use or for commercial activity. It would be desirable to have a method of heating water which does not require the active provision of energy to directly heat the water.

Another problem associated with creation of potable water and/or heated water is the lack of a portable device which is simple and structure, which does not require an excessive amount of components, and which can be easily transported and set up. The disadvantage is generally associated with the prior art is that attempts to provide systems for heating, distillation, and/or purification of water typically require large fixed location devices which are not easily transportable. It would be desirable to have a device that was easy to transport, easy to install, and require minimal number of components.

Several attempts have been made by the prior art to address these issues. For the purpose of creating potable water, several methods have been provided by the prior art. One such method is disclosed by U.S. Pat. No. 4,978,458 to Inagaki et al. which discloses a method of purifying water by passing a stream of water through a narrow tube. The narrow tube is heated to a high temperature via a solar lens which destroys any contaminants in the water. The water emanating from the tube is potable as a result of the heating process. In this method, the water is not distilled. Rather, it is sterilized due to high heat.

Another method of creating potable water is through the distillation process. This can be accomplished in employing heat from a variety of sources such as gas, electric, or solar. One method of using solar energy to create potable water is taught by U.S. Pat. No. 4,194,949 to Stark. Stark uses a Fresnel-type lens which is filled with the flow of preheated water. The water in the lens is heated by solar energy, and the lens simultaneously focuses light on a reservoir of water beneath the lens structure. The lower surface of the Fresnel-type lens acts as a condenser for water vapor from the water reservoir. The distilled water which is condensed from the water vapor is then channeled out of the device. While this device serves its intended purpose, it requires a complex arrangement of piping, and a complex fluid lens system. As a result, the device is relatively expensive, requires a fixed location, and requires a level of skill for installation and operation.

A different method of creating potable water is provided by Martes et al. in U.S. Pat. No. 4,921,580. Martes teaches a water distillation system which uses a spherical water reservoir that is partially surrounded by a parabolic reflector. Solar energy reflected in the parabolic reflector is directed to a spherical water reservoir which heats the water therein. The water is then converted to water vapor which is condensed by the system to create distilled water. A complex system is used to move the parabolic reflector such that it is constantly aligned with the sun. While this maximizes the efficiency of the Martes device, it also requires a complex and sophisticated control system to maintain the alignment of the parabolic reflector. As a result, this system is relatively expensive to manufacture, and requires skill to set up for operation. It would be desirable to have a method of distilling water, which has a simple structure, is inexpensive to manufacture, and is easy to install and operate.

In addition to solar devices such as those discussed above, prior art is also provided water distillers which are directly heated in non-solar energy to provide steam which is then condensed into distilled water. An example of such a device is disclosed by U.S. Pat. No. 4,601,789 to Bjorklund et al.

In addition to prior art devices which distilled water, the prior art has also provided a number of devices for heating water. For example, U.S. Pat. Nos. 4,282,861 and 4,287,879 to Roark feature solar hot water heaters which use conventional copper piping to pump water through solar panels and then return the water to a hot water tank. The Roark patents are a conventional closed loop systems that are designed to heat water, and are well known in the art.

Another known water heater is caught by U.S. Pat. No. 4,602,617 to Clegg. In Clegg, water is heated by solar energy which is concentrated by three lenses used in combination with conical mirrors. The conical mirrors focus like going to a heating element in a water reservoir which heats the water. As was the case with the devices discussed above, the Clegg device does not easily portable, and requires skill to align it for use.

Another solar water heater is taught by Varney et al. In U.S. Pat. No. 4,637,376. The Varney device uses a conical structure which reflects light into an insulated water reservoir to heat the water contained therein. Barney does not provide any means to capture water vapor and condense it.

While the prior art has provided a number of devices that distilled and/or heat water, it has failed to provide a device which can heat and distill water, which is easy to transport, which can be manufactured in any size to suit any given purpose, and which requires no alignment or skill to use.

### SUMMARY OF THE INVENTION

This invention provides a water heating chamber which has external walls that incorporate a plurality of lenses to direct sunlight from any direction into the chamber to heat the chamber contents. An input line provides water when necessary, and an output condensing structure channels water vapor out of the device for condensation into distilled water. Alternatively, water can be output from the chamber after heating to provide a supply of hot water. In addition, the chamber can be used to heat water for cooking purposes. Further, steam can be generated which can be used as an energy source for turbines. The chamber can be constructed in any suitable size for the purpose at hand. When used to provide steam for commercial use, the chamber would have a substantial size. When used for other purposes, such as cooking, the chamber can be small enough to be a replacement for a conventional teapot. The chamber can be fabricated from glass, or any other material suitable for creating a greenhouse effect inside the chamber.

### BRIEF DESCRIPTION OF THE DRAWINGS

FIG. 1 is a side view of a preferred embodiment of the invention which shows the heating chamber, a support base, and the condensing structure.

FIG. 2 is a top view of the heating chamber illustrated in FIG. 1. This figure illustrates the heating chamber wall and a plurality of lenses arranged around the heating chamber wall.

FIG. 3 is side view of a preferred embodiment of the invention which shows a heating chamber with lenses of various sizes such that the surface area of the distillation chamber covered by the lenses are maximized.

FIG. 4 is an exploded view of the preferred embodiment illustrated in FIG. 1.

FIG. 5 is a side view of an alternative preferred embodiment which illustrates an internal heating unit, and an alternative water input channel.

FIG. 6 is a top view of the alternative preferred embodiment of FIG. 5 which illustrates the internal heating unit inside the heating chamber.

FIG. 7 illustrates an exploded perspective view of an alternative preferred embodiment that shows the securing mechanism which secures the internal heating element to the support base.

FIG. 8 illustrates a perspective view of an alternative preferred embodiment of the heating chamber which is used to provide hot water.

FIG. 9 is a side cross-sectional view of the preferred embodiment of FIG. 8.

FIG. 10 illustrates an alternative embodiment which shows a large-scale water heating chamber providing steam for use by steam turbines and building steam heat.

FIG. 11 illustrates another alternative embodiment which shows a small water heating chamber used as a tea kettle.

### DETAILED DESCRIPTION OF THE PREFERRED EMBODIMENT

Prior to a discussion of the figures, an overview of the invention will be presented. The invention is a combination water distiller, hot water heater, and/or steam generator. It uses a heating chamber which is preferably fabricated from glass, such that when he enters the chamber in the visible light spectrum, it is absorbed by material within the heating chamber and re-radiated as infrared energy which is trapped by the glass. By using the greenhouse effect in this matter, when water is placed inside the heating chamber its temperature is rapidly raised. As a result, the water can be siphoned off as hot water, or allowed to continue to rise in temperature to generate steam. The steam generated by the invention can be condensed to make distilled water, or alternatively, the steam can be used to generate energy for devices such as steam turbines.

In the preferred embodiment, the heating chamber is fabricated from glass due to its well known properties in regard to the greenhouse effect. However, those skilled in the art will recognize that any suitable material can be used to fabricate the heating chamber so long as it has the ability to retain heat in the heating chamber in the same manner as glass.

The invention uses a plurality of lenses which are integrated into the wall of the heating chamber such that light striking the lenses is concentrated and projected into the heating chamber to accelerate the heating process. The heating chamber can be any size which is suitable for a particular task. For example, a small heating chamber can be used by individuals who require a small amount of water, as would be the case when camping or doing other personal activities. Likewise the upper limit of the heating chamber size can vary widely based on how much steam or hot water is required. In the case of commercial operations, a heating chamber can have a substantial size, holding thousands of gallons of water.

It should also be noted that while the figures used a generally cylindrical structure for the heating chamber, this is done for ease of discussion only. Those skilled in the art and recognize that the heating chamber can have any suitable shape. Preferably, the shape selected for the heating chamber will provide lenses mounted around the entire periphery of the heating chamber to allow solar energy to enter the heating chamber from any direction. As a result, while cylindrical heating chamber is illustrated, the heating chamber can also have a spheroid, rectangular, or other multifaceted shape. The only requirement is that light should be able to penetrate the heating chamber from multiple directions.

Another optional feature of this invention is the use of an internal heating element to absorb solar energy. An advantage of the internal heating element is that it heats up and directly heats water inside the heating chamber. In addition, some of the absorbed solar energy is re-radiated as infrared energy. When the re-radiated infrared energy strikes the inner wall of the heating chamber, it is prevented from leaving the heating chamber and thus continues to heat the water.

Having discussed the invention in general, we turn now to a detailed discussion of the drawings.

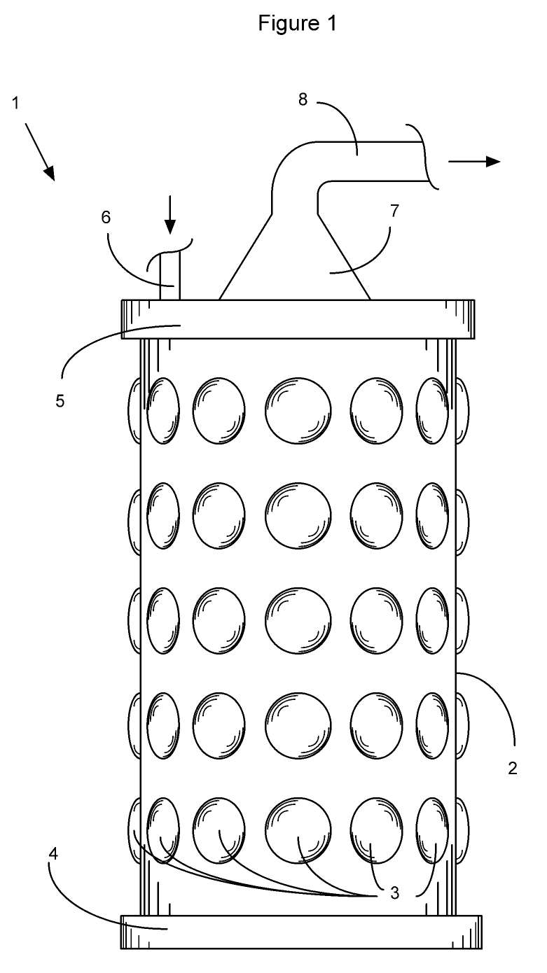

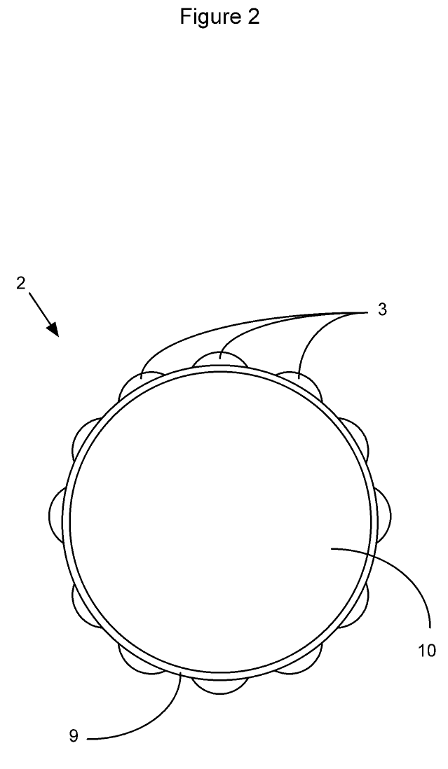

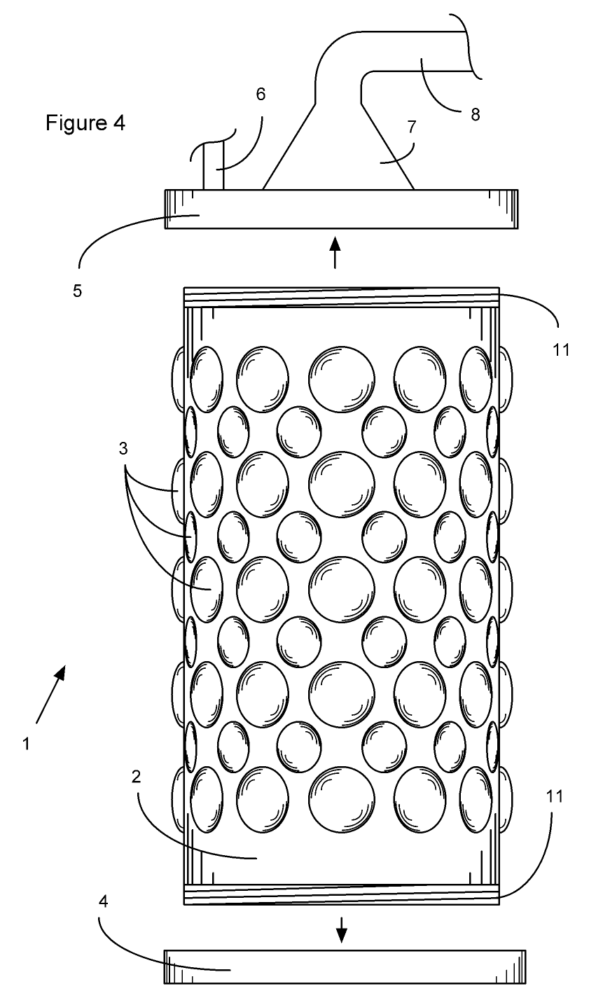

FIG. 1 is a side view of a preferred embodiment of the water heating/distillation system 1. The heating chamber 2 is fabricated from transparent material, preferably glass, which allows solar energy to penetrate the wall of the heating chamber 2. Also shown in this figure is a plurality of lenses 3 which concentrate solar energy and focus in on the internal chamber 10 (shown below in regard to FIG. 2) of the heating chamber 2. Also shown in this figure is support base 4 to which the heating chamber 2 is secured. In a preferred embodiment, the heating chamber 2 is secured to the support base 5 via watertight threading 11 (shown below in regard to FIG. 4).

Also shown in this figure is the condensing structure. In a preferred embodiment, the condensing structure comprises the heating chamber lid 5, the water input 6, the steam output port 7, and the steam output line 8. Those skilled in the art will recognize that the water input 6 can be placed in any suitable location including the support base 4. Likewise, the steam output port 7 on the steam output line 8 can take any suitable shape and be arranged in any suitable manner.

The support base 4 in the condensing structure can be fabricated from any suitable materials or materials. The only requirement is that the material be compatible with the heating chamber 2 and suitable for use in high temperature and wet environments.

FIG. 2 is a top view of the heating chamber illustrated in FIG. 1. This figure illustrates the heating chamber wall 9 of the heating chamber 2 and a plurality of lenses 3 arranged around the heating chamber wall 9. As can be seen from this figure, and the water heating/distillation system 1 can be placed in any position and still allow solar energy to penetrate into the internal chamber 10. Of course, other shapes such as spheroids may be even more advantageous in this regard.

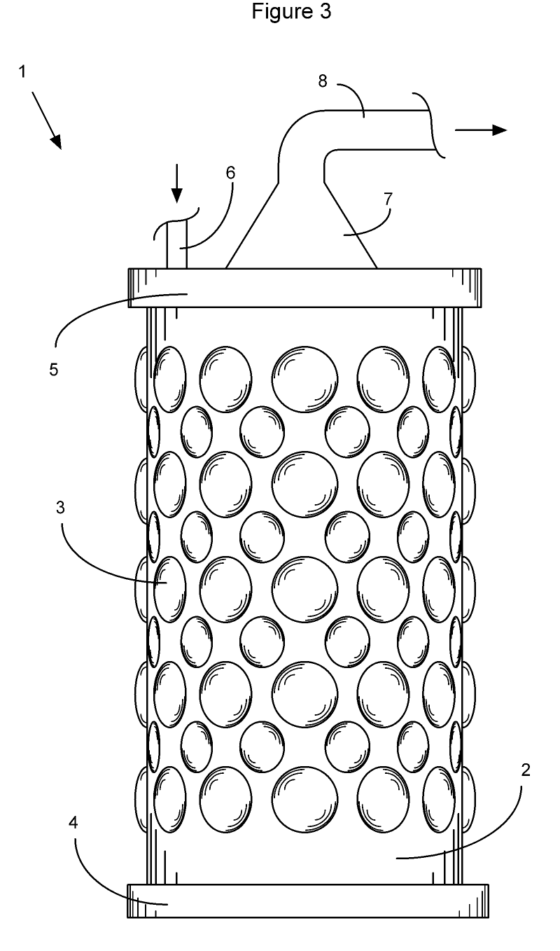

FIG. 3 is side view of an alternative preferred embodiment of the invention which shows a heating chamber 2 with lenses 3 of various sizes such that a greater proportion of the surface area of the heating chamber 2 is covered by the lenses 3. As a result, the effectiveness of the lenses 3 is maximized. Those skilled in the art will realize that the lenses 3 can be fabricated in any suitable size such as to maximize their effectiveness.

In a preferred embodiment, the lenses 3 are intended to be fabricated with the heating chamber 2 as a single unit. However, those skilled in the art will recognize that it is possible to use lenses 3 which are separate elements from the heating chamber 2 and secured to the heating chamber 2 in any suitable manner. Likewise, in the preferred embodiment the heating chamber 2 can also be fabricated from multiple segments which are joined together such that they form a leakproof chamber. When the water heating/distillation system 1 is fabricated as a smaller device, it may be preferable to mold a heating chamber 2 as a single unit. Further, the support base 4 may also be molded as an integral component of the heating chamber 2. However, as a practical matter, when the size of the water heating/distillation system 1 becomes larger, it is more likely that the most efficient way of fabricating it will be to fabricated in segments and secure them together on-site.

FIG. 4 is an exploded view of the preferred embodiment illustrated in FIG. 1. In this figure, threading 11 on the top and bottom ends of the heating chamber 2 are used to secure the heating chamber 2 to the heating chamber lid 5 and the support base 4, respectively. While threading 11 is used in a preferred embodiment, those skilled in the art will recognize that any suitable method of attaching a heating chamber 2 to the heating chamber lid 5 and the support base 4 can be used. Further, different attachment means can be used at either end of the heating chamber 2.

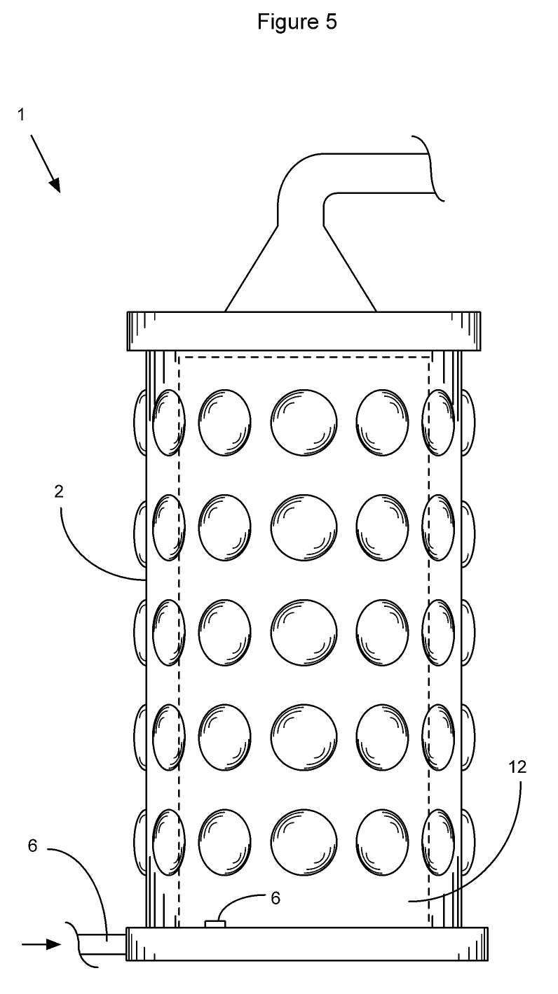

FIG. 5 is a side view of an alternative preferred embodiment of the water heating/distillation system 1 which illustrates an internal heating element 12 position inside of the heating chamber 2. An advantage of using heating element 12 is that increases the effectiveness of the water heating/distillation system 1. In particular, the heating element 12 is fabricated from a material which will absorb the solar energy entering the heating chamber 2. Once the energy is absorbed, some of it will be converted to heat energy which will be directly transferred to the water inside of the internal chamber 10. In addition, some of the energy will be converted by the heating element 12 and re-radiated as infrared energy. However, the re-radiated infrared energy will be trapped inside of the internal chamber 10 by heating chamber wall 9 and lenses 3 which are both fabricated from glass. As a result, the heating element 12 accelerates the heating process for transferring energy to the water in the internal chamber can buy two methods: direct heat transfer, and infrared emission.

Also shown on this figure is an alternative water input channel 6 which inputs water into the internal chamber 10 by way of the support base 4.

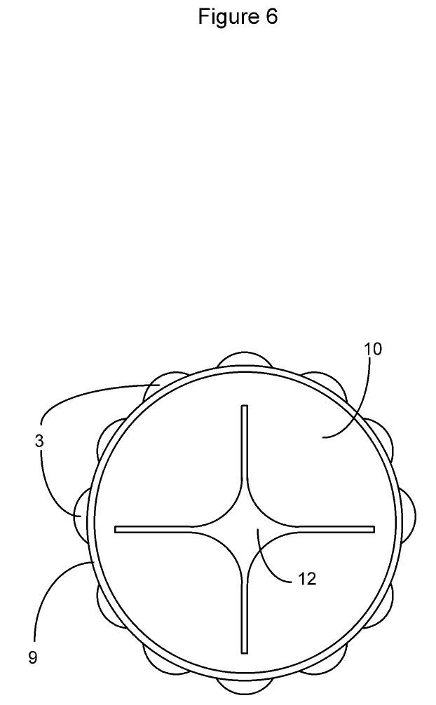

FIG. 6 is a top view of the alternative preferred embodiment of FIG. 5 which illustrates the internal heating element 12 inside the heating chamber 10. In practice, internal heating element 12 can be fabricated in any suitable shape. However, in the preferred embodiment, internal heating element is fabricated with relatively thin extensions to minimize the amount of space taken up inside of heating chamber 10. As a result, the space inside of heating chamber 10 available for water is maximized.

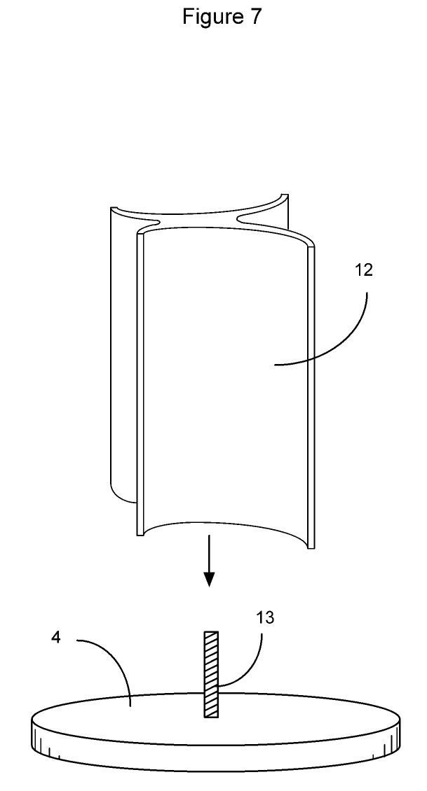

FIG. 7 illustrates an exploded perspective view of a preferred embodiment of internal heating element 12 that shows the securing mechanism 13 which secures the internal heating element 12 to the support base 4. In this example, securing mechanism 13 is a threaded bolt which threaded into a threaded aperture (not shown) on the bottom of internal heating element 12. However, those skilled in the art will recognize that any number of securing mechanisms, well known in the art, can be used to secure these two components together. In addition, for ease of illustration the threading on support base 4 which secures it to heating chamber 2 is not shown.

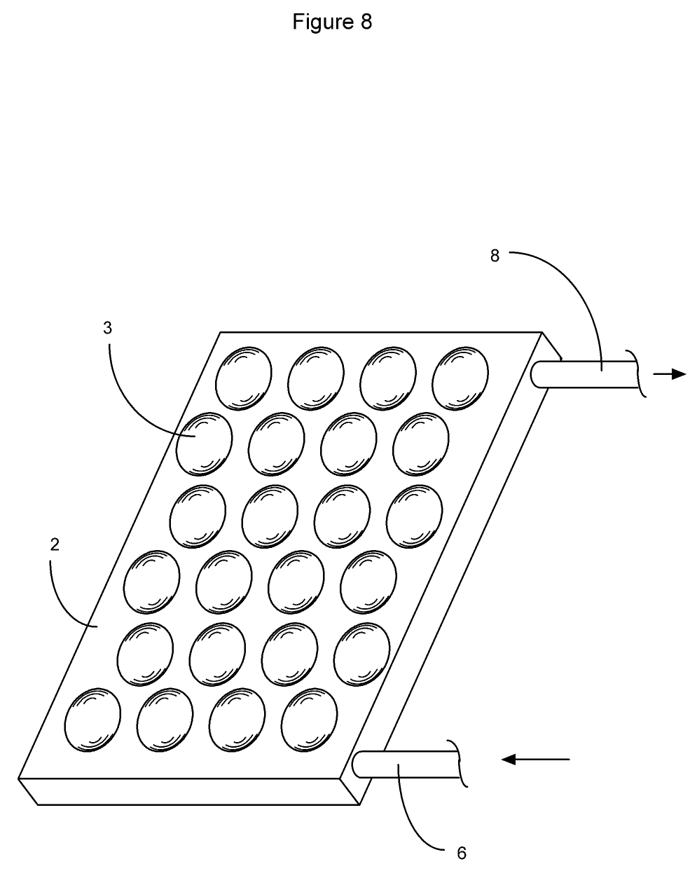

FIG. 8 illustrates a perspective view of an alternative preferred embodiment of the heating chamber 2 which is used to provide hot water. In this embodiment, the condensing structure is not required since the intent is to output hot water. Water is input via water input 6 and output via water output 8. The physical structure of heating chamber 2 can take any suitable form. In this illustration, a heating chamber 2 is structured as a flat rectangular device suitable for mounting on a structure such as a roof. In operation, the water is directly heated by the lenses 3 as it passes through the heating chamber 2. As roof mounted water heating units typically rest on a sloped surface, the water output 8 will typically be above the water input 6 such that the warmer water will rise to the water output 8.

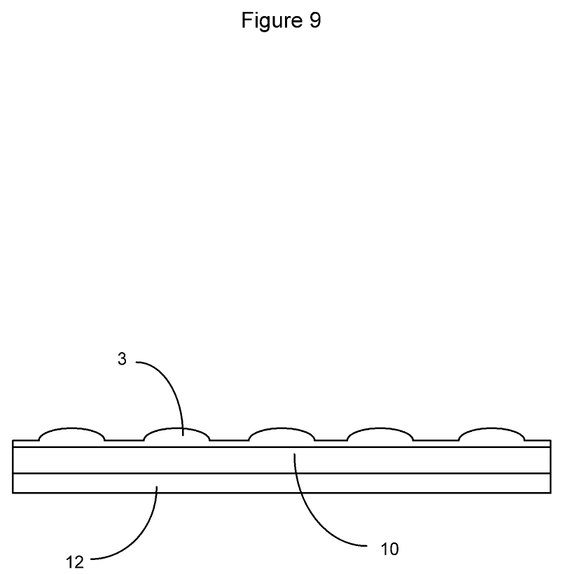

FIG. 9 is a side cross-sectional view of the preferred embodiment of FIG. 8. In this figure, solar energy passes through lenses 3 and enters internal chamber 10. Some of the solar energy directly heats the water inside of the internal chamber 10. However, some of the solar energy passes through the water and strikes internal heating element 12. Internal heating element 12 then directly warms the water, and indirectly warms the water by re-radiating infrared energy as discussed above.

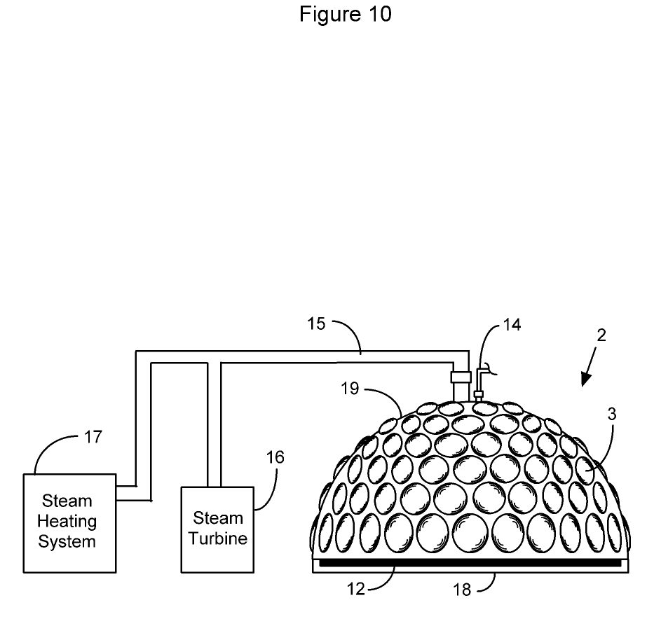

In FIG. 10, an alternative embodiment of the invention is illustrated which uses a large scale water heating chamber 2 to generate a substantial amount of steam. Water is input, as needed, to water heating chamber 2 via water input 14. Water can be input manually or via a suitable automated system that dynamically replenishes water levels. Water level controls suitable for this purpose are well known in the art.

In this embodiment, water heating chamber 2 has an outer wall 19 with a substantially hemispherical shape. The purpose of the hemispherical shape is to allow sunlight to enter the water heating chamber 2 regardless of the position of the sun in the sky. Sunlight enters the water heating chamber 2 is directed to internal heating element 12 by lenses 3. Preferably, substantially all of the outer wall 19 is covered by lenses 3. As internal heating element 12 becomes hotter, it heats the water in the water heating chamber 2 and eventually creates steam. The steam is output to steam pipe 15 which delivers the steam to any system that uses steam. In this figure, the steam is delivered to a steam turbine 16 for generating electricity, and to a steam heating system 17 that can provide steam heat to a residential or commercial building.

Also shown is insulating floor 18 that prevents heat from the internal heating element 12 from escaping through the bottom of the water heating chamber 2. Those skilled in the art will recognize that the water heating chamber 2, when used to provide a large amount of steam, must to have a substantial size to generate the needed amount of energy.

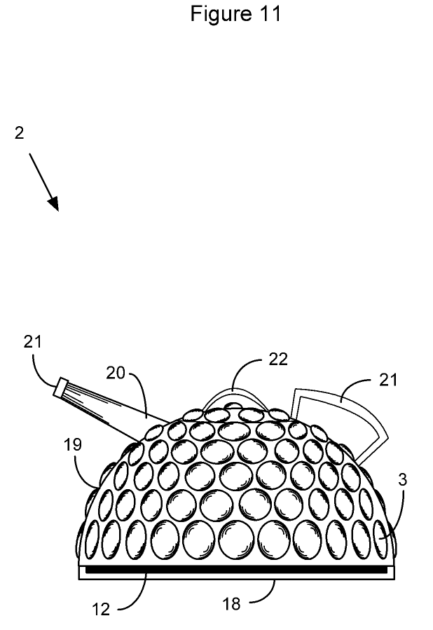

FIG. 11 is an alternative preferred embodiment that provides a solar powered water heating chamber 2 which functions as a tea kettle. This embodiment has a similar structure to the embodiment of FIG. 10. The differences are that this embodiment is much smaller, having the approximate size of a conventional tea kettle. Further, this embodiment uses a handle 21 to lift the water heating chamber 2, a lid and lid handle assembly 22 to provide access to fill the water heating chamber 2, and a spout 20 which whistle spout 21 to pour heated water out of the water heating chamber 2.

An advantage provided this embodiment is that when used by campers, the water heating chamber 2 can provide hot water for tea, coffee or other cooking purposes without requiring a fire. As a result, the chances of inadvertently staring a fire when camping out is reduced.

While specific embodiments have been discussed to illustrate the invention, it will be understood by those skilled in the art that variations in the embodiments can be made without departing from the spirit of the invention. Therefore, the invention shall be limited to the scope of the claims.

I claim:

1. A water heating system, comprising:
a chamber for holding water to be heated, the chamber wall are light transmissive walls to allow sunlight to enter the chamber, and non-transmissive for infrared energy such that when light enters the chamber and is converted to infrared, a greenhouse effect is created;
a plurality of lens positioned on the chamber wall, the lenses further positioned such that they direct sunlight into the chamber;
whereby water placed in the chamber is heated by the greenhouse effect.

2. A system, as in claim 1, wherein:
the chamber further comprises an internal heating element.

3. A system, as in claim 2, wherein:
the chamber is substantially fabricated from glass.

4. A system, as in claim 2, further comprising:
a water input for adding water to the chamber.

5. A system, as in claim 4, wherein:
the water is added to the chamber manually.

6. A system, as in claim 4, further comprising:
the water is automatically added to the chamber when needed.

7. A system, as in claim 4, further comprising:
at least one steam output.

8. A system, as in claim 7, further comprising:
a steam turbine generator having a steam input attached to the steam output.

9. A system, as in claim 7, further comprising:
a steam heat system having a steam input attached to the steam output.

10. A system, as in claim 7, further comprising:
a distiller having an input attached to the steam output for inputting steam; and
means to condense the steam into potable water.

11. A system, as in claim 4, further comprising:
a hot water output.

12. A system, as in claim 11, wherein:
the water input is a lid and handle assembly.

13. A system, as in claim 12, further comprising:
A handle, secured to the chamber such that the chamber may be lifted by the handle.

14. A system, as in claim 13, wherein:
the hot water output is a spout.

15. A system, as in claim 14, further comprising:
an insulating floor in the bottom of the chamber.

16. A system, as in claim 15, wherein:
the internal heating element is located on the insulating floor of the chamber.

17. A system, as in claim 16, wherein:
the chamber is substantially fabricated from glass.
